(19) United States
(12) Patent Application Publication
(10) Pub. No.: US 2003/0110209 A1
(43) Pub. Date: Jun. 12, 2003

(54) Method of producing a multimedia media

(76) Inventors: Alexander C. Loui, Penfield, NY (US); Yawcheng Lo, Rochester, NY (US); David R. Cok, Rochester, NY (US); Thomas M. Stephany, Churchville, NY (US)

Correspondence Address: Eastman Kodak Company, 343 State Street, Rochester, NY, 14650-2201, US

(21) Appl. No.: 10/020,560

(22) Filed: Dec. 7, 2001

(51) Int. Cl. G06F 15/16

(52) U.S. Cl. 709/203; 709/231

(57) ABSTRACT

A method of producing a multimedia media by accessing, selecting, arranging, composing, compressing, and previewing multimedia materials. The method comprises the intercommunication of computers, imaging devices or kiosks communicating over an internet or communications network to author a multimedia media. The devices share capability over the network to produce the multimedia media. The resultant multimedia media is returned from a fulfillment center.

### CROSS REFERENCE TO RELATED APPLICATION

Reference is made to commonly assigned application U.S. Ser. No. ______ (Kodak Docket No. 82359/SLP), entitled “SYSTEM AND METHOD FOR AUTHORING A MULTIMEDIA ENABLED DISC”, filed on Jun. 20, 2001 in the names of Loui et al., and which is assigned to the assignee of this application.

### FIELD OF THE INVENTION

The present invention relates generally to digital imaging, and in particular to a method of producing a multimedia media comprised of a plurality of images.

### BACKGROUND OF THE INVENTION

Services and software are available which provide multimedia photographic content to consumers.

For example, Photoworks, Inc.(www.photoworks.com) markets and provides direct-to-consumer photo-finishing, digital imaging services and products, including 35 mm film and photo-finishing services and related products on a direct-to-consumer mail order basis. Photoworks offers a service which allows customers to create cards using proprietary software, Pictures on Disk, where each film roll is delivered on a CD.

Another example is YesVideo of San Jose, Calif. which offers a service that converts consumer home video to DVD and CD, the CD being in standard computer CD-ROM format. Additionally, LifeClips of Acton, Mass. accepts NTSC VCR and camcorder tape formats including VHS, S-VHS, VHS-C, BetaMax, 8 mm, Hi8, Digital8 and miniDV (standard play only) and converts them into a custom DVD. The original content must be sent to LifeClips.

In home computer software, MGI Corporation of Toronto, Canada offers VideoWave 5 which provides video editing and DVD authoring tools. Business and home users can create videos for CD, DVD, VCD and VHS using the program.

While such services and software may have achieved certain degrees of success in their particular applications, these do not allow a consumer to compose and encode a multimedia production at one location and generate the resultant CD product at a second location.

Accordingly, a need continues to exist for a method which allows a user having limited or no computing equipment to be able to compose a multimedia media of his/her own liking or design at one location and, when satisfied with the result, produce/fulfill the media at a second location. As such, the user is not required to have all computing/producing equipment needed to produce a multimedia product.

### SUMMARY OF THE INVENTION

An object of the present invention is to overcome one or more of the problems set forth above.

Another object of the present invention is to provide a method which allows a user having limited or no computing equipment to be able to compose a multimedia media of his/her own liking or design at one location and, when satisfied with the result, produce/fulfill the media at a second location.

These objects are given only by way of illustrative example. Thus, other desirable objectives and advantages inherently achieved by the disclosed invention may occur or become apparent to those skilled in the art. The invention is defined by the appended claims.

According to one aspect of the invention, there is provided a method of producing a multimedia media. The method comprises the steps of: (a) using a software program at a first location to arrange a plurality of digital images to produce a multimedia composition; (b) using the software at the first location to encode the multimedia composition to produce a digital bit-stream; (c) accessing the digital bit-stream at the first location to view the digital bit-stream; (d) generating an order request to create the multimedia media comprised of the digital bit-stream; (e) transmitting the bit-stream to a second location remote from the first location; and (f) fulfilling the order request.

According to another aspect of the invention, there is provided a method of producing a multimedia media. The method comprises the steps of: (a) a user using a software program at a first location to arrange a plurality of digital images to produce a multimedia composition; (b) the user transmitting the multimedia composition to a service provider located at a second location remote from the first location; (c) the service provider encoding the multimedia composition to produce a digital bit-stream; (d) the service provider transmitting the digital bit-stream to the user at the first location; (e) the user accessing the digital bit-stream at the first location to view the digital bit-stream; (f) the user generating an order request to create the multimedia media comprised of the digital bit-stream; (g) transmitting the order request to the service provider; and (h) fulfilling the order request.

According to yet another aspect of the invention, there is provided a method of producing a multimedia media. The method comprises the steps of: (a) a user located at a first location accessing a thumbnail version of each of a plurality of digital images located at a second location remote from the first location; (b) the user using a software program at the first location to arrange at least one of the plurality of digital images to produce a multimedia composition script; (c) the user transmitting the multimedia composition script to a service provider located at the second location; (d) the service provider encoding the at least one of the plurality of digital images in accordance with the script to produce a digital bit-stream; (e) transmitting the digital bit-stream to the user at the first location; (f) the user accessing the digital bit-stream at the first location to view the digital bit-stream; (g) the user generating an order request to create the multimedia media comprised of the digital bit-stream; and (h) transmitting the order request to the service provider for fulfillment of the order request.

According to a still further aspect of the invention, there is provided a method of producing a multimedia media. The method comprises the steps of: (a) providing a service provider with a undeveloped exposed film roll at a remote site for development to produce a plurality of digital images; (b) a user located at a first location using a software program to arrange a thumbnail version of at least one of the plurality of digital images located at a second location remote from the first location to produce a multimedia composition script; (c) the user transmitting the multimedia composition script to a service provider located at the second location; (d) the service provider encoding the at least one of the digital images in accordance with the script to produce a digital bit-stream; (e) transmitting the digital bit-stream to the user at the first location; (f) the user accessing the digital bit-stream at the first location to view the digital bit-stream; (g) the user generating an order request to create the multimedia media comprised of the digital bit-stream; and (h) transmitting the order request to the service provider for fulfillment of the order request.

According to yet still further aspect of the invention, there is provided a method of producing a multimedia media. The method comprises the steps of: (a) at a first location, accessing a thumbnail version of at least one of a plurality of digital images located at a second location remote from the first location; (b) using a software program at the first location to arrange the at least one of the plurality of digital images to produce a multimedia composition script; (c) transmitting the at least one of the plurality of digital images to the first location; (d) encoding the at least one of the plurality of digital images at the first location in accordance with the script to produce a digital bit-stream; (e) the user accessing the digital bit-stream at the first location to view the digital bit-stream; (f) the user generating an order request to create the multimedia media comprised of the digital bit-stream; (g) transmitting the order request to a service provider located a location remote from the first location; and (h) transmitting the digital bit-stream to the service provider at the first location for fulfillment of the order request.

The present invention provides a method which allows a user having limited or no computing equipment to be able to compose a multimedia media of his/her own liking or design at one location and, when satisfied with the result, produce/fulfill the media at a second location. As such, the present invention provides a benefit to a user who does not have sophisticated computer equipment to fulfill a multimedia media. That is, the present invention provides for the sharing of production capabilities, including production software, with a central production location and preview of the final product. This preview could be either on the customer's computer if the capability exists, or by sharing capability with the central fulfillment location if the computer capability does not exist. Additionally it could be accomplished using a networked device such as an imaging device (e.g., a kiosk such as a Kodak Picture Maker from Eastman Kodak Company) if the customer has insufficient computer capability.

### BRIEF DESCRIPTION OF THE DRAWINGS

The foregoing and other objects, features, and advantages of the invention will be apparent from the following more particular description of the preferred embodiments of the invention, as illustrated in the accompanying drawings.

FIG. 1 shows a schematic of system components in accordance with the present invention.

FIG. 2 shows a schematic of a multimedia media production method in accordance with the present invention.

FIG. 3 shows a flow diagram of a method in accordance with the present invention wherein the multimedia media composition occurs on a local machine/computer with content retrieved from that local computer, MPEG bit-stream generation occurs on the local computer, with customer/user preview accomplished directly at the local computer.

FIG. 4 shows a flow diagram of a method in accordance with the present invention wherein the multimedia media composition occurs on a local computer with content retrieved from that local computer; the finished arrangement of the local content being sent to a remote computer for MPEG bit-stream generation, and the MPEG bit-stream being sent back to said local computer for customer/user preview.

FIG. 5 shows a flow diagram of a method in accordance with the present invention wherein the multimedia media composition occurs on a local computer with content retrieved from a remote computer; the finished arrangement of the remote content having MPEG bit-stream generation performed on the local computer, and making the locally generated MPEG bit-stream available at the local computer for customer/user preview.

FIG. 6 shows a flow diagram of a method in accordance with the present invention; when multimedia media composition occurs on a local computer with content retrieved from a remote computer; the finished arrangement of the content being sent to a remote computer for MPEG bit-stream generation, and said MPEG bit-stream being sent back to said local computer for customer/user preview.

### DETAILED DESCRIPTION OF THE INVENTION

The following is a detailed description of the preferred embodiments of the invention, reference being made to the drawings in which the same reference numerals identify the same elements of structure in each of the several figures.

The term multimedia refers to the inclusion or involving of several media. Thus, multimedia material comprises a plurality of media material, and is intended to provide a digital multimedia composition (such as a digital graphics album) with a rich and full context and presentation, and expand a viewer's enjoyment when viewing. Such multimedia material can include, but is not limited to, images, audio, video and any combination thereof.

The present invention provides a method for the composition, authoring, compression, preview and fulfillment of a multimedia media on a variety of equipment, whether consumer or commercial, including imaging devices such as kiosks. The present invention provides for the use of resources as a distributed system. This allows a machine/computer system with reduced or less than ideal capabilities to be capable of authoring a multimedia media to by using resources at a remote site/location when the deficient machine/computer is unable to perform a necessary function/operation.

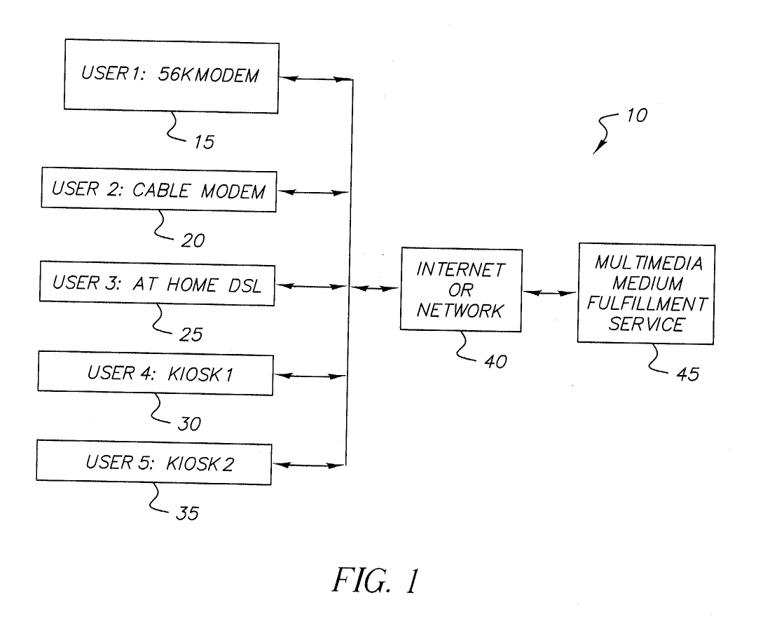

Referring to FIG. 1, there is shown generally a system 10 in accordance with the present invention. One or more users may utilize the system of the present invention, and each user may employ various means to utilize the system. For example, User 1 (noted at 15) employs a standard 56K modem. User 2 (noted at 20) employs a broadband cable modem. User 3 (noted at 25) employs a home broadband in the form of a Digital Subscriber Line (DSL). User 4 (noted at 30) employs a first kiosk. User 5 (noted at 35) employs a second kiosk. The users communicate to an internet or a communications network 40, which is in turn connected to a remote service provider or remote Multimedia Media Fulfillment Service 45. Examples of a Multimedia Media Fulfillment Service 45 are retailers offering processing services, wholesale processing labs, photoprocessing laboratories, and on-line processing services such as Ofoto.

It should be noted that Users 1-5 (15-35) can comprise different capabilities according to the configuration of the equipment that they are using. For example User 1 (15) which employs a standard 56K modem, may have a slower processor which is mostly incapable of encoding MPEG bit-streams. In this situation, any multimedia content/material worked upon by User 1 (15) would be transmitted over network 40 to Multimedia Media Fulfillment Service 45. Therefore, User 1 (15) who employs a reduced capacity computer, can participate in the content creation process without any deficiencies by sharing necessary services with Fulfillment Service 45 over network 40. Accordingly, the present invention, through its capability sharing philosophy, the multimedia media creation process is available to the general consumer.

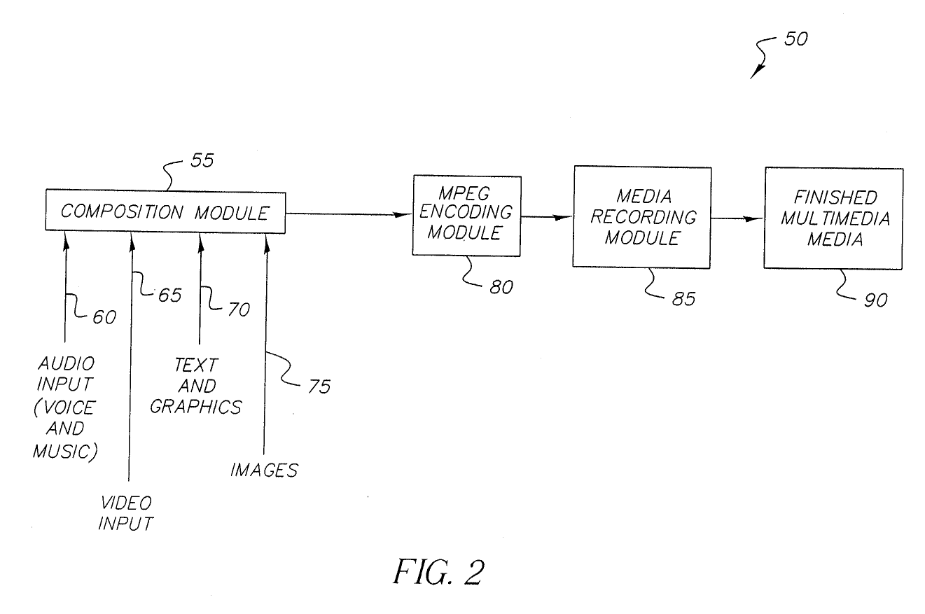

FIG. 2 shows a Multimedia Media Production Method 50 used in accordance with the present invention. A composition module 55 accepts a plurality of inputs including, for example, audio 60, video 65, text and graphics 70, and images 75. The inputs are arranged to produce a multimedia composition, for example a digital graphics album. The output of composition module 55 is transmitted to an MPEG Encoding Module 80, and then to Media Recording Module 85 which creates a multimedia media 90 comprising the multimedia composition. Multimedia media 90 is then delivered/distributed to the user. Multimedia media 90 can be media suitable for use with a variety of equipment, whether consumer or commercial, for example, a VCD or a DVD.

It should be understood that in spirit with the distributed system architecture of the present invention that capabilities described within FIG. 2 can reside in various locations according to the needs and capabilities of the equipment which is attached to the Multimedia Media Fulfillment Service 45 referenced in FIG. 1.

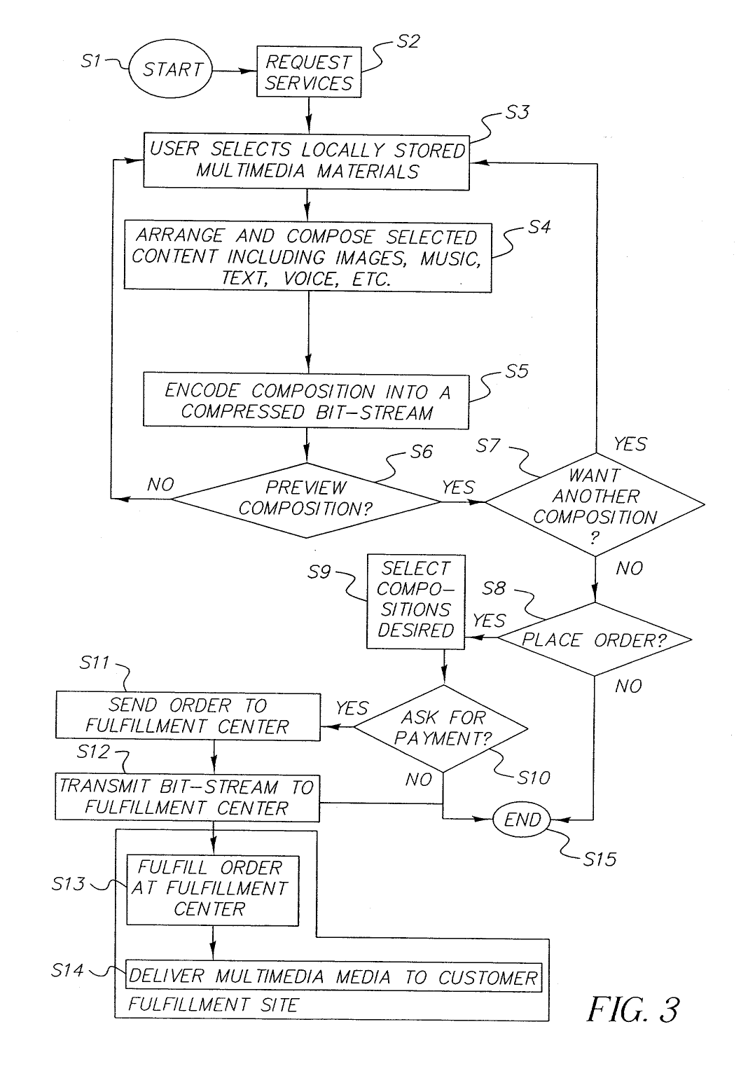

Referring now to FIG. 3, there is shown a flow diagram of a method in accordance with the present invention wherein the multimedia media composition occurs on a local system with content retrieved from that local system, MPEG bit-stream generation occurs on the local system, with customer/user preview accomplished directly at the local system. The method starts (step S1) by the user interacting with a software program operating on a system located at a first (local) location, for example, a computer, kiosk, or other imaging device such as referenced in FIG. 1 at 15-35. The software/system displays a prompt to request the type of services the user may wish to use (step S2). The user accesses/selects a plurality of locally stored multimedia materials (step S3). These locally stored multimedia materials could be physically stored on the system the user is accessing (e.g., 15-35 referenced in FIG. 1), or available locally from a removable or an external storage media such as a CD-ROM, memory card, or PCMCIA card. The user arranges and composes the selected content (step S4) to produce a multimedia composition or presentation.

Using software at the first location, the multimedia composition is encoded (step S5) into a compressed digital bit-stream of a type used by the encoding software. In a preferred embodiment, after the compression, the software would allow the user to preview the digital bit-stream (i.e., the composition) (step S6) whereby the user can determine if the user is satisfied with the results. If the user is not satisfied with the results, the software program would return to step S3, that would allow the user to change the selection of the multimedia material. If the user is satisfied with the results, the user would be prompted (step S7) for the creation of another composition. If another composition is desired, the user would return to step S3 where multimedia materials could be selected to create another composition. If no further composition is desired, the user would be prompted (step S8) to generate an order request to create the multimedia media comprising the digital bit-stream representative of the multimedia composition. If no order request is generated at step S8, then the routine would end (step S15). If the user wishes to generate an order request, the user would select/indicate which composition(s) would be desired (step S9). At step S10, payment and other user and product delivery information would be collected from the user. Payment can be provided using credit card information. If no payment information is provided at step S10, the routine would end (step S15). If information is provided at step S10, the order request and encoded digital bit-stream is transmitted to a fulfillment center (steps S11 and S12), for example Multimedia Media Fulfillment Service 45, located at a second location remote from the first location. At the fulfillment center, the order request is fulfilled (step S13) and arrangements are made for delivery of the multimedia media to the user (step S14) using known delivery methods.

As noted from the flow chart of FIG. 3, if multiple bit-streams are created before the order request is generated, steps S3 through S6 are repeated. That is, the software program at the first location is used to arrange a second plurality of digital multimedia material to produce a second multimedia composition. The software program at the first location is used to encode the second multimedia composition to produce a second digital bit-stream. The transmitted order request would request the creation of a multimedia media comprised of the first digital bit-stream and the second digital bit-stream.

The digital bit-stream may comprise low or high resolution images.

The method of disclosed in FIG. 3 may further comprise the step of transmitting an electronic message to the user indicative of the generation and transmission of the order request and/or indicative of the fulfillment of the order request.

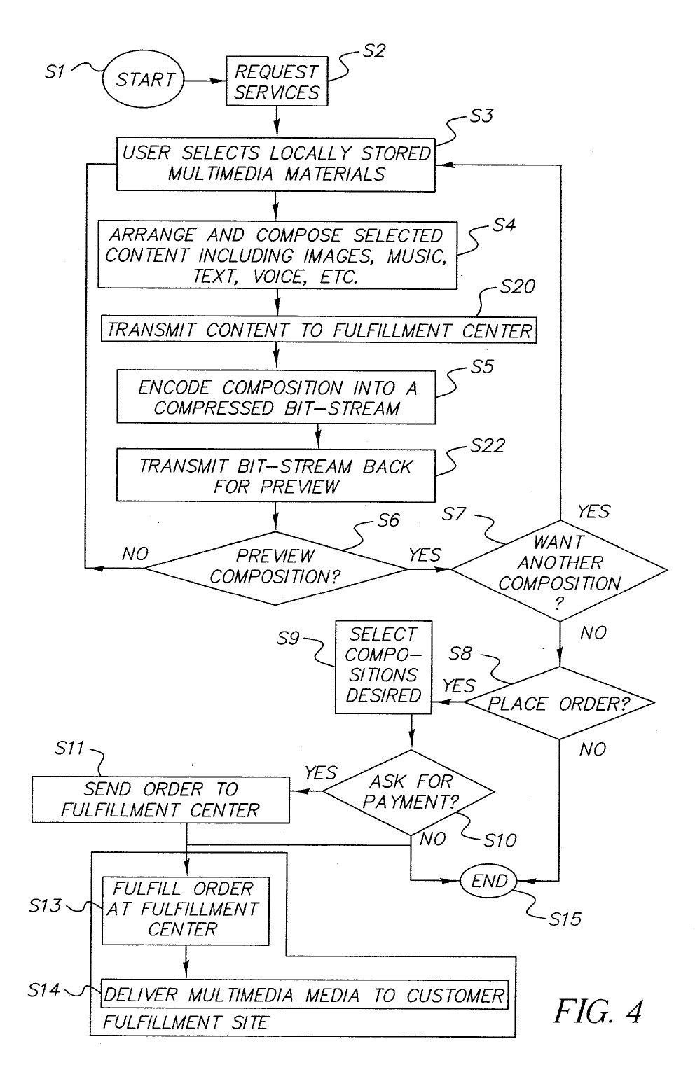

FIG. 4 shows a flow diagram of a method in accordance with the present invention wherein the multimedia media composition occurs on a local system with content retrieved from that local system; the finished arrangement of the local content being sent to a remote system for MPEG bit-stream generation, and the MPEG bit-stream being sent back to said local system for customer/user preview.

Steps S1 through S4 are as described above, with the user interacting with a software program operating on a system located at a first (local) location; the system displays a prompt to request the type of services the user may wish to use; the user accesses/selects and arranges a plurality of locally stored multimedia materials to produce a multimedia composition.

At step S20, the multimedia composition is transmitted to a service provider or fulfillment center located at a second location remote from the first location. Such a step would be employed when the user's system is unable or has difficulty with encoding the multimedia composition. At the fulfillment center, the multimedia composition is compressed into a bit-stream of a type used by the encoding software (step S5). After this compression at the fulfillment center, the software transmits the compressed bit-stream (or a lower resolution of the compressed bit-stream) back to the user (step S22).

In a preferred embodiment, after the compression, the software would allow the user to preview the digital bit-stream (i.e., the composition) (step S6) whereby the user can determine if the user is satisfied with the results. If the user is not satisfied with the results, the software program would return to step S3 to allow the user to change the selection of the multimedia material. If the user is satisfied with the results, the user would be prompted (step S7) for the creation of another composition. If another composition is desired, the user would return to step S3 where multimedia materials could be selected to create another composition. If no further composition is desired, the user would be prompted (step S8) to generate an order request to create the multimedia media comprising the digital bit-stream representative of the multimedia composition. If no order request is generated at step S8, then the routine would end (step S15). If the user wishes to generate an order request, the user would select/indicate which composition(s) would be desired (step S9). At step S10, payment and other user and product delivery information would be collected from the user. Payment can be provided using credit card information. If no payment information is provided at step S10, the routine would end (step S15).

If information is provided at step S10, the order request is transmitted to the fulfillment center (steps S11). At the fulfillment center, the order request is fulfilled (step S13) and arrangements are made for delivery to the user (step S14) using known delivery methods. Note that the encoded bit-stream does not need to be transmitted to the fulfillment center since it is retained at the fulfillment center at steps S20 and S22.

As described with regard to the method of FIG. 3, multiple bit-streams can be composed prior to the generation of an order request for a multimedia media. As such, a plurality of multimedia compositions can be disposed on one multimedia media. Similarly, the composition can be previewed (step S6) and edited (steps S3 and S4) until the user is satisfied with the composition.

The method of disclosed in FIG. 4 may further comprise the step of transmitting an electronic message to the user indicative of the generation and transmission of the order request and/or indicative of the fulfillment of the order request.

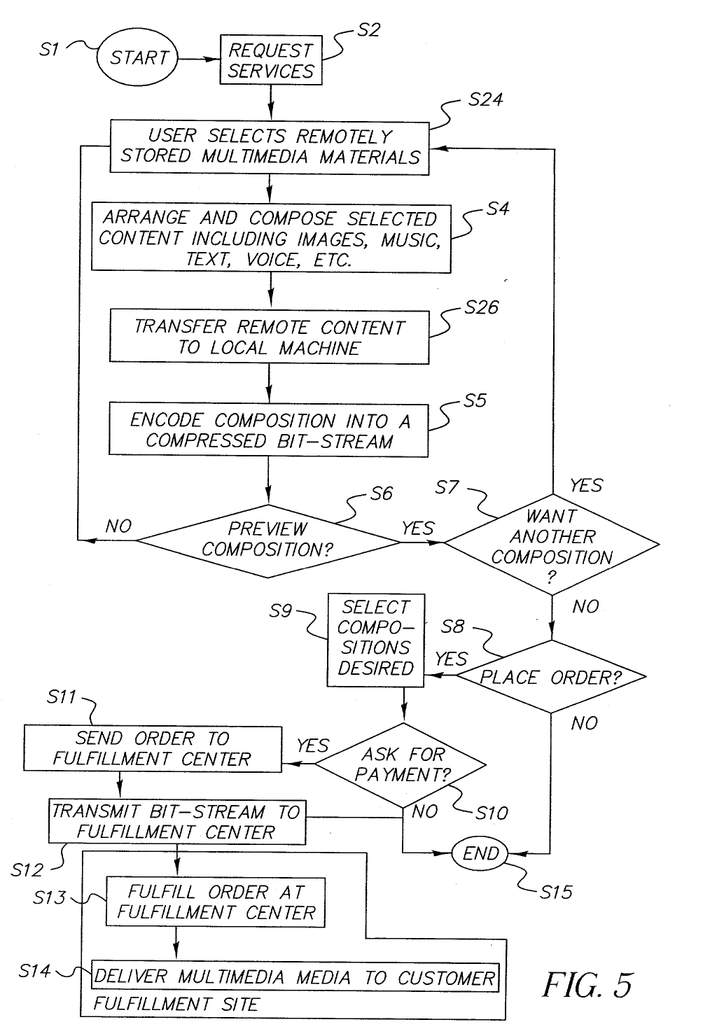

FIG. 5 shows a flow diagram of a method in accordance with the present invention wherein the multimedia media composition occurs on a local system with content retrieved from a remote system; the finished arrangement of the remote content having MPEG bit-stream generation performed on the local system, and making the locally generated MPEG bit-stream available at the local system for customer/user preview.

Steps S1 and S2 are as described above, with the user interacting with a software program operating on a system located at a first (local) location, and the system displays a prompt to request the type of services the user may wish to use. At step S24, the user then selects a plurality of remotely stored multimedia materials. These remotely stored multimedia materials could be physically stored on the remote system the user is accessing (i.e., located at fulfillment service 45), or from a removable or external storage media such as a CD-ROM, memory card or PCMCIA card. The user would then arrange and compose the selected content into a multimedia composition (step S4). Next, if the user has a system capable of encoding the multimedia composition, the selected remote content would be transmitted to the local system (step S26) to be compressed into a bit-stream of a type used by the encoding software.

Using software at the first location, the multimedia composition is encoded (step S5) into a compressed digital bit-stream of a type used by the encoding software. In a preferred embodiment, after the compression, the software would allow the user to preview the digital bit-stream (i.e., the composition) (step S6) whereby the user can determine if the user is satisfied with the results. If the user is not satisfied with the results, the software program would return to step S3, that would allow the user to change the selection of the multimedia material. If the user is satisfied with the results, the user would be prompted (step S7) for the creation of another composition. If another composition is desired, the user would return to step S3 where multimedia materials could be selected to create another composition. If no further composition is desired, the user would be prompted (step S8) to generate an order request to create the multimedia media comprising the digital bit-stream representative of the multimedia composition. If no order request is generated at step S8, then the routine would end (step S15). If the user wishes to generate an order request, the user would select/indicate which composition(s) would be desired (step S9). At step S1, payment and other user and product delivery information would be collected from the user. Payment can be provided using credit card information. If no payment information is provided at step S10, the routine would end (step S15). If information is provided at step S10, the order request and encoded digital bit-stream is transmitted to a fulfillment center (steps S11 and S12) located at a second location remote from the first location. At the fulfillment center, the order request is fulfilled (step S13) and arrangements are made for delivery of the multimedia media to the user (step S14) using known delivery methods.

As described above with regard to the method of FIGS. 3 and 4, multiple bit-streams can be composed prior to the generation of an order request for a multimedia media. As such, a plurality of multimedia compositions can be disposed on one multimedia media. Similarly, the composition can be previewed (step S6) and edited (steps S24 and S4) until the user is satisfied with the composition.

The method of disclosed in FIG. 5 may further comprise the step of transmitting an electronic message to the user indicative of the generation and transmission of the order request and/or indicative of the fulfillment of the order request.

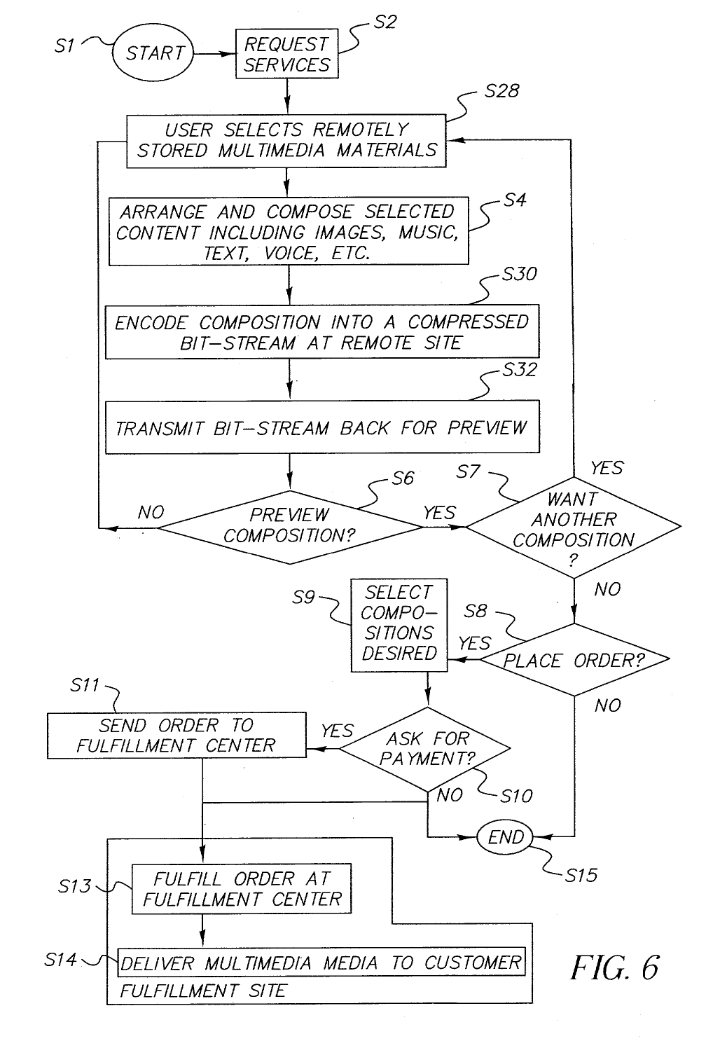

FIG. 6 shows a flow diagram of a method in accordance with the present invention; when multimedia media composition occurs on a local system with content retrieved from a remote system; the finished arrangement of the content being sent to a remote system for MPEG bit-stream generation, and said MPEG bit-stream being sent back to said local system for customer/user preview.

Steps S1 and S2 are as described above, with the user interacting with a software program operating on a system located at a first (local) location, and the system displays a prompt to request the type of services the user may wish to use.

The user accesses and selects (step S28) a plurality of remotely stored multimedia materials. These remotely stored multimedia materials could be physically stored on the remote system the user is accessing (i.e., Fulfillment Service 45), or could be from a removable or external storage media such as a CD-ROM, memory card or PCMCIA card. The user would then arrange and compose the selected content (or via the thumbnails representation) into a multimedia composition (step S4). Next, if the user's local system is not adapted for encoding the multimedia composition, the composition (i.e., the selected content or a script of the composition; the script being instruction/notes/notations/outline defining the assembly/ordering/components of the composition) would be transmitted to the remote system to be compressed into a bit-stream of a type used by the encoding software (step S30). After compression, the bit-stream (or a lower resolution of the bit stream) would be transmitted to the user at the first location (step S32) wherein the user could preview the composition in an effort to see if the user is satisfied with the results.

If the user is not satisfied with the results, the software program would return to step S28, allowing the user to change the selection of the multimedia material. If the user is satisfied with the results, the user would be prompted (step S7) for the creation of another composition. If another composition is desired, the user would return to step S28 where multimedia materials could be selected to create another composition. If no further composition is desired, the user would be prompted (step S8) to generate an order request to create the multimedia media comprising the digital bit-stream representative of the multimedia composition. If no order request is generated at step S8, then the routine would end (step S15). If the user wishes to generate an order request, the user would select/indicate which composition(s) would be desired (step S9). At step S10, payment and other user and product delivery information would be collected from the user. Payment can be provided using credit card information. If no payment information is provided at step S10, the routine would end (step S15). If information is provided at step S10, the order request is transmitted to a fulfillment center (step S11) located at a second location remote from the first location. At the fulfillment center, the order request is fulfilled (step S13) and arrangements are made for delivery of the multimedia media to the user (step S14) using known delivery methods.

Note that the encoded bit-stream does not need to be transmitted to the fulfillment center since it is retained at the fulfillment center at step S30. In addition, if the multimedia materials are located remotely, and the encoding is accomplished remotely, it may be desired to only transmit thumbnail versions of any accessed images from the remote location to the local location to compose and arrange. Alternately, only a low resolution bit-stream can be transmitted at step S32 for preview, with the high resolution bit-stream being disposed at the remote location.

In a further method, a user may provide a service provider with a roll of exposed film, and request the service provider to develop the exposed film roll at a remote site to produce a plurality of digital images. These digital images can be stored at the remote site for access by a user in accordance with the methods disclosed in FIGS. 5 and 6. As such, a user located at a first location would access a thumbnail version of the digital images located at the remote site.

A computer program product may include one or more storage media, for example; magnetic storage media such as magnetic disk (such as a floppy disk) or magnetic tape; optical storage media such as optical disk, optical tape, or machine readable bar code; solid-state electronic storage devices such as random access memory (RAM), or read-only memory (ROM); or any other physical device or media employed to store a computer program having instructions for controlling one or more computers to practice the methods according to the present invention.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

### Parts List

10 system components

15 User 1

20 User 2

25 User 3

30 User 4

35 User 5

40 Internet or network

45 Multimedia Media Fulfillment Service

50 Multimedia Media Production Method

55 composition module

60 audio

65 video

70 text and graphics

75 images

80 MPEG Encoding Module

85 media recording module

90 multimedia media

What is claimed is:

1. A method of producing a multimedia media, comprising the steps of:
(a) using a software program at a first location to arrange a plurality of digital images to produce a multimedia composition;
(b) using the software at the first location to encode the multimedia composition to produce a digital bit-stream;
(c) accessing the digital bit-stream at the first location to view the digital bit-stream;
(d) generating an order request to create the multimedia media comprised of the digital bit-stream;
(e) transmitting the bit-stream to a second location remote from the first location; and
(f) fulfilling the order request.

2. The method of claim 1, further comprising the steps of:
using the software program at the first location to arrange a second plurality of digital images to produce a second multimedia composition;
using the software program at the first location to encode the second multimedia composition to produce a second digital bit-stream; and
transmitting the order request to the service provider to create the multimedia media comprised of the digital bit-stream and the second digital bit-stream.

3. The method of claim 1, further comprising the step of, prior to transmitting the order request, using the software program to modifying the arrangement of the plurality of digital images.

4. The method of claim 1, further comprising the step of, prior to fulfilling the order request, providing payment for the multimedia media.

5. The method of claim 4, wherein payment is provided by providing a credit card number.

6. The method of claim 1, further comprising the step of using the software program at the first location to include audio material with the plurality of digital images to produce the multimedia composition.

7. The method of claim 1, further comprising the step of using the software program at the first location to include textual information with the plurality of digital images to produce the multimedia composition.

8. The method of claim 1, wherein the digital bit-stream is low resolution.

9. The method of claim 1, further comprising the step of transmitting an electronic message indicative of the fulfillment of the order request.

10. The method of claim 1, further comprising the steps of:
generating an order request; and
transmitting an electronic message indicative of the generation and transmission of the order request.

11. A method of producing a multimedia media, comprising the steps of:
(a) a user using a software program at a first location to arrange a plurality of digital images to produce a multimedia composition;
(b) the user transmitting the multimedia composition to a service provider located at a second location remote from the first location;
(c) the service provider encoding the multimedia composition to produce a digital bit-stream;
(d) the service provider transmitting the digital bit-stream to the user at the first location;
(e) the user accessing the digital bit-stream at the first location to view the digital bit-stream;
(f) the user generating an order request to create the multimedia media comprised of the digital bit-stream; and
(g) transmitting the order request to the service provider for fulfillment of the order request.

12. The method of claim 11, further comprising the steps of:
using the software program at the first location to arrange a second plurality of digital images to produce a second multimedia composition;
the user transmitting the second multimedia composition to the service provider; and
the service provider producing the digital bit-stream by encoding the second multimedia composition.

13. The method of claim 11, further comprising the step of, prior to transmitting the order request, using the software program to modifying the arrangement of the plurality of digital images.

14. The method of claim 11, further comprising the step of, prior to fulfilling the order request, providing payment for the multimedia media.

15. The method of claim 14, wherein payment is provided by providing a credit card number.

16. The method of claim 11, further comprising the step of using the software program at the first location to include audio material with the plurality of digital images to produce the multimedia composition.

17. The method of claim 11, further comprising the step of using the software program at the first location to include textual information with the plurality of digital images to produce the multimedia composition.

18. The method of claim 11, wherein the digital bit-stream is low resolution.

19. The method of claim 1, further comprising the step of transmitting an electronic message indicative of the fulfillment of the order request.

20. The method of claim 11, further comprising the steps of:
generating an order request; and
transmitting an electronic message indicative of the generation and transmission of the order request.

21. A method of producing a multimedia media, comprising the steps of:
(a) providing a software program at a first location for arranging a plurality of digital images to produce a multimedia composition;
(b) transmitting the multimedia composition to a second location remote from the first location;
(c) encoding the multimedia composition at the second location to produce a digital bit-stream;
(d) transmitting the digital bit-stream to the first location;
(e) accessing the digital bit-stream at the first location to view the digital bit-stream;
(f) generating an order request to create the multimedia media comprised of the digital bit-stream; and
(g) transmitting the order request.

22. A method of producing a multimedia media, comprising the steps of:
(a) a user located at a first location accessing a thumbnail version of each of a plurality of digital images located at a second location remote from the first location;
(b) the user using a software program at the first location to arrange at least one of the plurality of digital images to produce a multimedia composition script;
(c) the user transmitting the multimedia composition script to a service provider located at the second location;
(d) the service provider encoding the at least one of the plurality of digital images in accordance with the script to produce a digital bit-stream;
(e) transmitting the digital bit-stream to the user at the first location;
(f) the user accessing the digital bit-stream at the first location to view the digital bit-stream;
(g) the user generating an order request to create the multimedia media comprised of the digital bit-stream; and
(h) transmitting the order request to the service provider for fulfillment of the order request.

23. The method of claim 22, further comprising the steps of:
using the software program at the first location to arrange at least one of a second plurality of digital images to produce a second multimedia composition script;
the user transmitting the second multimedia composition script to the service provider; and
encoding the at least one of the second plurality of digital images in accordance with the second multimedia composition script to produce a second digital bit-stream.

24. The method of claim 22, further comprising the step of, prior to transmitting the order request, using the software program to modifying the arrangement of the plurality of digital images.

25. The method of claim 22, further comprising the step of, prior to fulfilling the order request, providing payment for the multimedia media.

26. The method of claim 25, wherein payment is provided by providing a credit card number.

27. The method of claim 22, further comprising the step of using the software program at the first location to include audio material with the at least one of the plurality of digital images to produce the multimedia composition script.

28. The method of claim 22, further comprising the step of using the software program at the first location to include textual information with the at least one of the plurality of digital images to produce the multimedia composition script.

29. The method of claim 22, wherein the digital bit-stream is low resolution.

30. The method of claim 22, further comprising the step of transmitting an electronic message indicative of the fulfillment of the order request.

31. The method of claim 22, further comprising the steps of:
generating an order request; and
transmitting an electronic message indicative of the generation and transmission of the order request.

32. A method of producing a multimedia media, comprising the steps of:
(a) at a first location, accessing a thumbnail version of each of a plurality of digital images located at a second location;
(b) using a software program at the first location to arrange at least one of the plurality of digital images to produce a multimedia composition script;
(c) transmitting the multimedia composition script to the second location;
(d) encoding the at least one of the plurality of digital images at the second location in accordance with the script to produce a digital bit-stream;
(e) transmitting the digital bit-stream to the first location;
(f) accessing the digital bit-stream at the first location to view the digital bit-stream;
(g) generating an order request to create the multimedia media comprised of the digital bit-stream; and
(h) transmitting the order request to the second location.

33. A method of producing a multimedia media, comprising the steps of:
(a) providing a service provider with a undeveloped exposed film roll at a remote site for development to produce a plurality of digital images;
(b) a user located at a first location using a software program to arrange a thumbnail version of at least one of the plurality of digital images located at a second location remote from the first location to produce a multimedia composition script;
(c) the user transmitting the multimedia composition script to a service provider located at the second location;
(d) the service provider encoding the at least one of the digital images in accordance with the script to produce a digital bit-stream;
(e) transmitting the digital bit-stream to the user at the first location;
(f) the user accessing the digital bit-stream at the first location to view the digital bit-stream;
(g) the user generating an order request to create the multimedia media comprised of the digital bit-stream; and
(h) transmitting the order request to the service provider for fulfillment of the order request.

34. The method of claim 33, further comprising the steps of:
using the software program at the first location to arrange at least one of a second plurality of digital images to produce a second multimedia composition script;
the user transmitting the second multimedia composition script to the service provider; and
encoding the at least one of the second plurality of digital images in accordance with the second multimedia composition script to produce a second digital bit-stream.

35. The method of claim 33, further comprising the step of, prior to transmitting the order request, using the software program to modifying the arrangement of the plurality of digital images.

36. The method of claim 33, further comprising the step of, prior to fulfilling the order request, providing payment for the multimedia media.

37. The method of claim 36, wherein payment is provided by providing a credit card number.

38. The method of claim 33, further comprising the step of using the software program at the first location to include audio material with the at least one of the plurality of digital images to produce the multimedia composition script.

39. The method of claim 33, further comprising the step of using the software program at the first location to include textual information with the at least one of the plurality of digital images to produce the multimedia composition script.

40. The method of claim 33, wherein the digital bit-stream is low resolution.

41. The method of claim 33, further comprising the step of transmitting an electronic message indicative of the fulfillment of the order request.

42 The method of claim 33, further comprising the steps of:
generating an order request; and
generating an order request; and
transmitting an electronic message indicative of the generation and transmission of the order request.

43. A method of producing a multimedia media, comprising the steps of:
(a) at a first location, accessing a thumbnail version of at least one of a plurality of digital images located at a second location remote from the first location;
(b) using a software program at the first location to arrange the at least one of the plurality of digital images to produce a multimedia composition script;
(c) transmitting the at least one of the plurality of digital images to the first location;
(d) encoding the at least one of the plurality of digital images at the first location in accordance with the script to produce a digital bit-stream;
(e) the user accessing the digital bit-stream at the first location to view the digital bit-stream;
(f) the user generating an order request to create the multimedia media comprised of the digital bit-stream;
(g) transmitting the order request to a service provider located a location remote from the first location; and
(h) transmitting the digital bit-stream to the service provider at the first location for fulfillment of the order request.

44. The method of claim 43, further comprising the steps of:
using the software program at the first location to arrange at least one of a second plurality of digital images to produce a second multimedia composition script;
the user transmitting the second multimedia composition script to the service provider; and
encoding the at least one of the second plurality of digital images in accordance with the second multimedia composition script to produce a second digital bit-stream.

45. The method of claim 43, further comprising the step of, prior to transmitting the order request, using the software program to modifying the arrangement of the plurality of digital images.

46. The method of claim 43, further comprising the step of, prior to fulfilling the order request, providing payment for the multimedia media.

47. The method of claim 46, wherein payment is provided by providing a credit card number.

48. The method of claim 43, further comprising the step of using the software program at the first location to include audio material with the at least one of the plurality of digital images to produce the multimedia composition script.

49. The method of claim 43, further comprising the step of using the software program at the first location to include textual information with the at least one of the plurality of digital images to produce the multimedia composition script.

50. The method of claim 43, wherein the digital bit-stream is low resolution.

51. The method of claim 43, further comprising the step of transmitting an electronic message indicative of the fulfillment of the order request.

52. The method of claim 43, further comprising the steps of:
generating an order request; and
transmitting an electronic message indicative of the generation and transmission of the order request.

53. A computer storage product having at least one computer storage media having instructions stored therein causing one or more computers to perform the method of claim 1.
